(19) United States
(12) Patent Application Publication
(10) Pub. No.: US 2026/0124729 A1
(43) Pub. Date: May 7, 2026

(54) Tool Clamping Device and Oscillating Multifunction Tool

(71) Applicant: Robert Bosch GmbH, Stuttgart (DE)

(72) Inventors: Marcell Boldizsar Tarczali, Bad Wörishofen (DE); Adam Laszlo Krokos, Kács (HU); Manuel Tobias Gross, Tuebingen (DE)

(21) Appl. No.: 19/380,582

(22) Filed: Nov. 5, 2025

(30) Foreign Application Priority Data
Nov. 7, 2024 (DE) 10 2024 210 699.2

(51) Int. Cl. B25F 3/00; B24B 23/04; B25F 5/00; B27B 19/00

(52) U.S. Cl. CPC B25F 3/00; B25F 5/006; B24B 23/046; B27B 19/006

(57) ABSTRACT

A tool clamping device for an oscillating multifunction tool includes (i) at least one tool mounting unit, (ii) at least one actuation unit to secure a tool or release the tool from the tool mounting unit, and (iii) at least one damping element arranged between the actuation unit and the tool mounting unit. The dampening element is formed as an elastomer.

This application claims priority under 35 U.S.C. § 119 to application no. DE 10 2024 210 699.2, filed on Nov. 7, 2024 in Germany, the disclosure of which is incorporated herein by reference in its entirety.

### BACKGROUND

A tool clamping device for an oscillating multifunction tool, with at least one tool mounting unit and with at least one actuation unit for securing a tool or releasing the tool from the tool mounting unit and with at least one dampening element arranged between the actuation unit and the tool mounting unit, has already been proposed.

### SUMMARY

The disclosure proceeds from a tool clamping device for an oscillating multifunction tool, with at least one tool mounting unit and with at least one actuation unit for securing a tool or releasing the tool from the tool mounting unit and with at least one dampening element arranged between the actuation unit and the tool mounting unit.

It is proposed that the dampening element is designed as an elastomer. The tool is preferably an accessory of the oscillating multifunction tool. The tool clamping device is preferably provided to replace a tool arranged on the tool mounting unit, in particular without any other mechanism, with another tool. The tool mounting unit is preferably provided to couple the tool secured thereto to a drive unit of the oscillating multifunction tool to a force and/or torque transfer from the drive unit to the tool. For example, the tool may be configured as a sawing tool, a milling tool, a polishing tool, or the like. Preferably, the tool mounting unit defines a pivot axis around which the tool is pivotable by the drive unit. The tool mounting unit preferably comprises at least one securing element for a positively-locking and/or force-locking, in particular magnetic and/or friction-locking, securing of the tool to a tool receptacle of the tool mounting unit. For example, the at least one securing element can be configured as an extendable and retractable pin, as a hook, as a gripper, as a clamp, as a magnetic holder, or the like. The actuation unit is preferably provided to move the at least securing element and thereby secure or release the tool. Preferably, the actuation unit comprises at least one actuating element for actuation by a user, for example in the form of a tensioning lever, a slider, a switch, or the like. Alternatively or additionally, the actuation unit comprises at least one actuator to control the actuation unit using a control unit of the oscillating multifunction tool.

With respect to the pivot axis, the actuation unit and the dampening element are preferably arranged at one end of the tool mounting unit and the tool receptacle preferably forms an opposite end of the tool mounting unit. The tool mounting unit preferably comprises at least one transmission element for transferring a force and/or a torque from the actuation unit to the at least one securing element. The dampening element is preferably arranged relative to the pivot axis between the actuation unit and the tool mounting unit. Preferably, the dampening element prevents direct physical contact between the actuation unit and the tool mounting unit. The dampening element is preferably provided to ensure a transmission of force and/or torque to the tool mounting unit upon actuation of the actuation unit. The dampening element is preferably provided to counteract a force and/or torque transmission from the tool mounting unit to the actuation unit when the tool is operated.

The term “provided” is to be understood in particular as specifically programmed, designed and/or equipped. The fact that an object is provided for a specific function should be understood in particular to mean that the object fulfills and/or executes this specific function in at least one application and/or operating mode.

Due to the embodiment according to the disclosure, vibration dampening between the tool mounting unit and the actuation unit can advantageously be easily achieved. In particular, the dampening element and the actuation unit are advantageously easy to mount and advantageously quick to mount, particularly compared to devices that use a spring as the dampening element. Moreover, vibration dampening properties may advantageously be flexible to suit various embodiments, namely by adjusting raw materials for the elastomer and/or by adjusting the geometry of the dampening element. Moreover, electrical insulation of the actuation unit and the tool mounting unit can be achieved without any further measure.

It is further proposed that the dampening element comprises a disk-shaped base body. The base body preferably has a main extension plane, which is at least substantially perpendicular to the pivot axis. A “main extension plane” of a structural unit should be understood to be a plane which is parallel to a largest side surface of a smallest notional cuboid which just completely encloses the structural unit, and in particular extends through the midpoint of the cuboid. The expression “essentially perpendicular” is intended in particular to define an orientation of a direction relative to a reference direction, wherein the direction and the reference direction, in particular viewed in a projection plane, enclose an angle of 90° and the angle has a maximum deviation of in particular less than 8°, advantageously less than 5° and particularly advantageously less than 2°. The base body is in particular cylindrical, with a base surface and a cylinder axis perpendicular to it, which is aligned at least substantially parallel to the pivot axis. The base surface of the base body can be circular, oval, elliptical, or polygonal. The base body has a smaller, preferably by at least one factor 2, particularly preferably smaller by at least one factor 3, particularly preferably smaller at least one factor 5, maximum extension parallel to the pivot axis, in particular the cylinder axis, than perpendicular to the pivot axis. “Essentially parallel” is to be understood here in particular to mean an orientation of a direction relative to a reference direction, in particular in a plane, wherein the direction has a deviation relative to the reference direction that is in particular less than 8°, advantageously less than 5° and particularly advantageously less than 2°. As a result of the design according to the disclosure, the tool mounting unit can advantageously be kept compact.

It is further suggested that the dampening element comprises a, in particular the aforementioned, base body whose maximum transverse extension corresponds at least substantially to a transverse extension of the tool mounting unit and/or the actuation unit, which is parallel thereto. The maximum transverse extension of the base body is preferably at least substantially perpendicular to the cylinder axis. It should preferably be understood under a size “substantially corresponding” to a reference size that the size deviates by less than 25%, preferably by less than 15%, in particular by less than 10%, from the reference size. Preferably, the maximum transverse extension of the base body is less than or equal to the parallel transverse extension of the tool mounting unit and/or the actuation unit The parallel transverse extension of the tool mounting unit and/or the actuation unit preferably relates to an extension of the corresponding component at the location at which the dampening element is arranged. Parts of the tool mounting unit and/or the actuation unit spaced apart from the dampening element can have a larger, in particular significantly larger, transverse extension than the dampening element, for example an actuating element configured as a tensioning lever. The embodiment according to the disclosure can advantageously easily and efficiently achieve a decoupling of the actuation unit and the tool mounting unit with respect to vibrations and/or an electrical current flow.

It is further proposed that the dampening element comprises at least one mounting positive-locking element and the tool mounting unit and/or the actuation unit having a corresponding mounting positive-locking element. The mounting positive-locking element is preferably arranged on the base body. The mounting positive-locking element can in particular project out of the base body, in particular in a direction at least substantially parallel to the pivot axis, and/or as a recess of the base body. The mounting positive-locking element may in particular be configured as a pin, web, nub, rib, recess, blind hole, through-hole, or the like. Preferably, the dampening element comprises at least one actuating-side mounting positive-locking element arranged positively with the actuation unit. Preferably, the dampening element comprises at least one securing-side mounting positive-locking element, which is arranged positively with the tool mounting unit. The at least one actuating-side mounting positive-locking element and the securing-side mounting positive-locking element are preferably arranged on different sides of the base body relative to the pivot axis. By the embodiment according to the disclosure, a risk and/or extent of a faulty placement of the dampening element during mounting of the tool clamping device can advantageously be kept low. In particular, a consistently high reliability of vibration dampening during operation of the tool and/or the transmission of force may be achieved when actuating the actuation unit.

Furthermore, it is proposed that the dampening element comprises a receiving recess for receiving a fixing element of the tool mounting unit and/or the actuation unit. Preferably, the receiving recess is inset on a side of the base body facing the tool mounting unit. The separately formed fixing element is, for example, designed as a screw, a rivet, a pin, or the like. The fixing element is preferably provided to secure a terminating element of the tool mounting unit to the transmission element. The terminating element preferably comprises an abutment surface for receiving the dampening element. In particular, the abutment surface has a surface complementary to the dampening element. Preferably, the terminating element forms a mounting positive-locking element corresponding to the fuse-side mounting positive-locking element. The receiving recess is preferably arranged at an intersection of the pivot axis with the dampening element. The receiving recess is particularly provided for receiving a head of the fixing element. Alternatively, the fixing element is recessed in the terminating element. Due to the configuration according to the disclosure, an abrasion of the dampening element on the fixing element can advantageously be kept low and a functional capability of the dampening element can advantageously be kept high. In particular, the terminating element can be advantageously kept flat and the clamping device advantageously compact.

Further, it is proposed that the dampening element has at least one protrusion corresponding to the receiving recess as the mounting positive-locking element. Preferably, the corresponding protrusion forms the actuating-side mounting positive-locking element. The protrusion is in particular configured as nubs. In particular, a volume of the protrusion at least substantially corresponds to and/or is smaller than a negative space of the receiving recess. Preferably, a material thickness of the dampening element at the protrusion at least substantially corresponds to and/or is smaller than the maximum extension of the base body parallel to the pivot axis. Due to the configuration according to the disclosure, a force curve can be designed to be advantageously flexible when the actuating element is actuated.

It is further proposed that the dampening element form at least one mounting positive-locking element that breaks a rotational symmetry of the dampening element with respect to an axis perpendicular to a main extension plane of the dampening element, in particular the pivot axis. Preferably, the base body is rotationally symmetrical to the pivot axis. Preferably, the actuating-side mounting positive-locking element, and in particular the receiving recess, is arranged on the base body concentrically with the pivot axis. Preferably, the at least one securing-side mounting positive-locking member breaks the rotational symmetry. Preferably, the at least one securing-side mounting positive-locking member is arranged on the base body acentrically with respect to the pivot axis. Due to the design according to the disclosure, the dampening element has an advantageously simple Poka-Yoke design. In particular, the dampening element may advantageously be simply correctly aligned and arranged during assembly.

Further, it is proposed that the dampening element has a hardness of between 40 and 60 Shore A in accordance with ISO 7619-1. Preferably, the dampening element in a neutral position, in particular in a state not compressed by actuation of the actuation unit, causes a minimally low opposing force compared to a compression. Preferably, a hardness relative to a deformability of the dampening element increases during operation of the tool mounting unit.

Due to the embodiment according to the disclosure, a sufficient hardness for a force and/or torque transmission upon actuation of the actuation unit and a sufficient vibration dampening during operation of the tool mounting unit can advantageously be achieved.

It is further proposed that the dampening element is made of a rubber. For example, the dampening element is made from natural rubber (NR), nitrile rubber (NBR), ethylene-propylene diene monomer (EPDM), silicone rubber (VMQ), chloroprene rubber (CR), particularly neoprene, butyl rubber (IIR), or fluoro-rubber (FKM), particularly Viton. Due to the design according to the disclosure, the dampening element can advantageously be configured inexpensively, robustly, and flexibly adaptably.

Furthermore, an oscillating multifunction tool with at least one tool clamping device according to the disclosure and with at least one drive unit is proposed to drive a tool that can be secured to the tool clamping device. The drive unit preferably comprises an electric motor for pivoting the tool about the pivot axis, in particular at a frequency of more than 5000 vibrations per minute. Depending on the engine used, the drive unit preferably comprises at least one transmission for transmission of force and/or torque from the engine to the tool. The transmission may be at least partially integrated into the tool mounting unit. The oscillating multifunction tool preferably comprises at least one housing in which the drive unit, the actuation unit and/or the tool mounting unit are arranged together, in particular at least the actuating element and the tool receptacle being accessible from the outside and/or projecting out of the housing. The oscillating multifunction tool preferably comprises at least one power supply unit connected to a power supply at the drive unit. For example, the power supply unit comprises a power supply and/or a battery interface, in particular to connect a battery pack. The oscillating multifunction tool is preferably handheld, in particular able to be held with one hand, and preferably operable with one, in particular the same, hand. In particular, the oscillating multifunction tool has a mass of less than 5 kg, preferably of less than 3 kg. An oscillating multifunction tool, which is advantageously quick and easy to assemble, can be provided by the design according to the disclosure.

Further, a method for assembling a tool clamping device according to the disclosure is proposed. In at least one method step of the method, the tool mounting unit and the actuation unit are each pre-assembled separately. In at least one method step of the method, the dampening element is applied to the terminating element of the tool mounting unit, in particular such that the at least one securing-side mounting positive-locking element engages the corresponding mounting positive-locking element of the tool mounting unit. In at least one method step of the method, the actuating unit is arranged on the dampening element, in particular such that the at least one actuating side mounting positive-locking element engages the corresponding mounting positive-locking element of the actuating unit. Preferably, in at least one method step, a housing and/or a retaining ring of the clamping device is closed around the dampening element, the actuation unit and the tool mounting unit. As a result of the design according to the disclosure, the tool mounting unit can advantageously be easily assembled.

The clamping device according to the disclosure, the oscillating multifunction tool according to the disclosure, and/or the method according to the disclosure should not be limited to the application and embodiment described above. In particular, the clamping device according to the disclosure, the oscillating multifunction tool according to the disclosure, and/or the method according to the disclosure may have a number of individual elements, components, method steps, and units that differs from a number specified herein in order to fulfill a function described herein. Additionally, regarding the ranges of values indicated in this disclosure, values lying within the limits specified hereinabove are also provided to be considered as disclosed and usable as desired.

### BRIEF DESCRIPTION OF THE DRAWINGS

Further advantages follow from the description of the drawings below. The drawings show an exemplary embodiment of the disclosure. The drawings, the description, and the claims contain numerous features in combination. A person skilled in the art will appropriately also consider the features individually and combine them into additional advantageous combinations.

It shows:

FIG. 1 a schematic perspective representation of a multifunction oscillating tool according to the disclosure; and

FIG. 2 a schematic cross-section through a tool clamping device according to the disclosure of the oscillating multifunction tool according to the disclosure.

### DETAILED DESCRIPTION

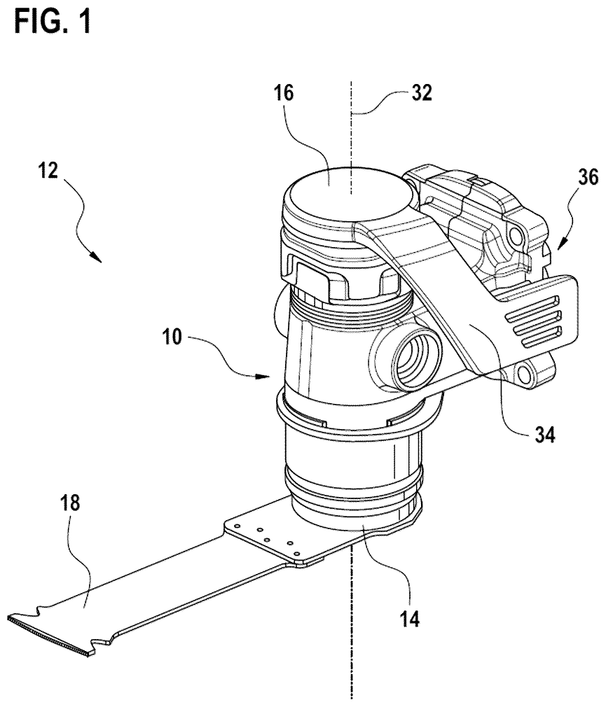

FIG. 1 shows an oscillating multifunction tool 12. The oscillating multifunction tool 12 includes at least one tool clamping device 10. The oscillating multifunction tool 12 includes at least one drive unit to drive a tool 18 secured to the tool clamping device 10. The tool 18 is preferably configured as a replaceable accessory for the oscillating multifunction tool 12, herein exemplified as a saw blade. The drive unit is preferably provided to move the tool 18 back and forth about a pivot axis 32. The drive unit preferably comprises an electric motor and a power supply, which may comprise, for example, a battery interface 36 and/or a power supply, as shown here.

The tool clamping device 10 comprises at least one tool mounting unit 14, which is preferably provided for coupling the tool 18 to the power unit or releasing the tool 18 from the oscillating multifunction tool 12. The tool mounting unit 14 is preferably formed concentrically with the pivot axis 32. Tool clamping device 10 includes at least one actuation unit 16 for securing the tool 18 to or releasing the tool 18 from the tool mounting unit 14. The actuation unit 16 here comprises, for example, a tensioning lever 34, which is provided for manual actuation. A tool receptacle of tool mounting unit 14 is preferably arranged at one end of tool mounting unit 14 along pivot axis 32. The actuation unit 16 is preferably arranged at the opposite end of the tool mounting unit 14 along the pivot axis of the tool receptacle. In particular, the actuation unit forms a support surface for placing a hand on the oscillating multifunction tool 10 during operation of the oscillating multifunction tool 10.

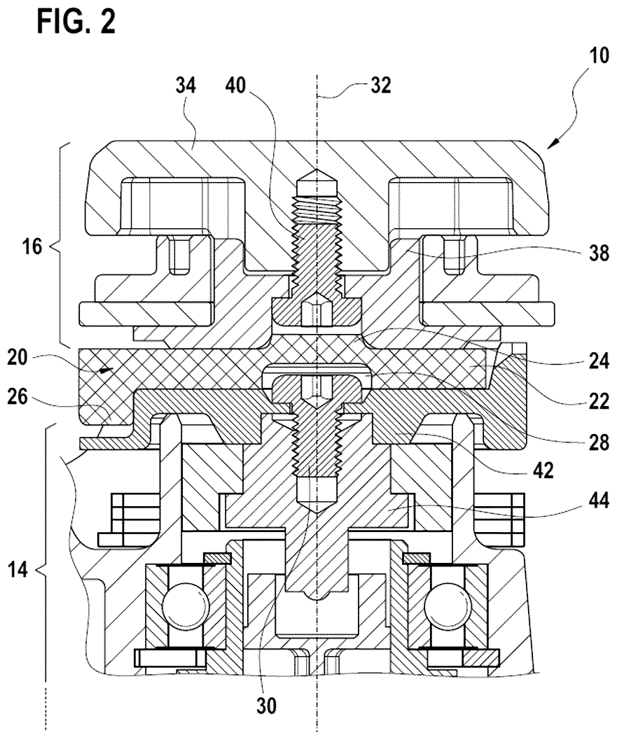

FIG. 2 shows a cross section of the tool clamping device 10, in a plane comprising the pivot axis 32. The actuation unit 16 preferably comprises at least one transmission element 38 for transferring a force and/or a torque from the lever 34 to the tool mounting unit 14. The transmission element 38 is preferably connected to the tensioning lever 34 by way of a lever fixing element 40, shown herein as a screw, for example. The tool clamping device 10 includes at least one dampening element 20 arranged between the actuation unit 16 and the tool mounting unit 14. The damping element 20 is preferably made of an elastomer. For example, the dampening element 20 is made from natural rubber (NR), nitrile rubber (NBR), ethylene-propylene diene monomer (EPDM), silicone rubber (VMQ), chloroprene rubber (CR), particularly neoprene, butyl rubber (IIR), or fluoro-rubber (FKM), particularly Viton.

The dampening element 20 comprises a disc-shaped base body 22. The base body 22 has a main extension plane, which is at least substantially perpendicular to the pivot axis 32. A maximum transverse extension of the dampening element 22 corresponds at least substantially to a transverse extension of the tool mounting unit 14 and/or the actuation unit 16 in parallel thereto. The tool mounting unit 14 preferably comprises a terminating element 42 on which the dampening element 20 abuts. The dampening element 20 is preferably arranged between the transmission element 38 and the terminating element 42, in particular being clamped. The terminating element 42 is preferably secured to a transmission element 44 of the tool mounting unit 14 by way of a fixing element 30, shown herein as a screw, for example. For example, the transmission element 44 of the tool mounting unit 14 is provided for transferring force and/or torque from the actuation unit 16 to a transmission of the drive unit and/or the tool 18. The terminating element 42 is preferably configured as an abutment for the laminar support of the base body 22 of the dampening element 20.

The dampening element 20 includes at least one mounting positive-locking element 24, 26 and the tool mounting unit 14 and/or the actuation unit 16 have a corresponding mounting positive-locking element. The dampening element 20 comprises a receiving recess 28 for receiving a fixing element 30 of the tool mounting unit 14. The dampening element 20 comprises at least one protrusion corresponding to the receiving recess 28 as the mounting positive-locking element 24. The mounting positive-locking element 24 preferably engages with the transmission element 38 of the actuation unit 16. The receiving recess 28 and the mounting positive-locking element 24 are preferably arranged concentrically with the pivot axis 32.

The dampening element 20 forms at least one further mounting positive-locking element 26, which breaks a rotational symmetry of the dampening element 20 with respect to the pivot axis 32 perpendicular to its main extension plane. The further mounting positive-locking element 26 is preferably arranged on the base body 22 acentrically to the pivot axis 32. The further mounting positive-locking element 26 is preferably configured as a protrusion. The further mounting positive-locking element 26 is preferably arranged at an edge of the base body 20 relative to a transverse direction perpendicular to the pivot axis 32. The further montage positive-locking element 26 preferably engages with the terminating element 42 of the tool mounting unit 14. Preferably, the dampening element 20 comprises a recess on the end of the base body 22 opposite to the further mounting positive-locking element 26, in which a protrusion of the terminating element 42 engages.

What is claimed is:

1. A tool clamping device for an oscillating multifunction tool, comprising:
at least one tool mounting unit;
at least one actuation unit configured to secure a tool or release the tool from the at least one tool mounting unit; and
at least one dampening element arranged between the at least one actuation unit and the at least one tool mounting unit,
wherein the at least one dampening element is formed as an elastomer.

2. The tool clamping device according to claim 1, wherein the at least one dampening element comprises a disk-shaped base body.

3. The tool clamping device according to claim 1, wherein the at least one dampening element comprises a base body, the maximum transverse extension of which corresponds at least substantially to a transverse extension of the at least one tool mounting unit and/or the at least one actuation unit that is parallel thereto.

4. The tool clamping device according to claim 1, wherein:
the at least one dampening element comprises at least one mounting positive-locking element, and
the at least one tool mounting unit and/or the at least one actuation unit comprises a corresponding mounting positive-locking element.

5. The tool clamping device according to claim 1, wherein the at least one dampening element comprises a receiving recess configured to receive a fixing element of the at least one tool mounting unit and/or the at least one actuation unit.

6. The tool clamping device according to claim 5, wherein the at least one dampening element comprises at least one protrusion corresponding to the receiving recess as the mounting positive-locking element.

7. The tool clamping device according to claim 1, wherein the at least one dampening element is configured to form at least one mounting positive-locking element, which breaks a rotational symmetry of the at least one dampening element with respect to an axis perpendicular to a main extension plane of the at least one dampening element.

8. The tool clamping device of claim 1, wherein the at least one dampening element has a hardness of between 40 and 60 Shore A in accordance with ISO 7619-1.

9. The tool clamping device according to claim 1, wherein the at least one dampening element is made of a rubber.

10. An oscillating multifunction tool, comprising:
at least one tool clamping device according to claim 1; and
at least one drive unit configured to drive a tool that is secured to the at least one tool clamping device.

11. A method of assembling the tool clamping device according to claim 1.
